(19) United States
(12) Patent Application Publication
(10) Pub. No.: US 2022/0153609 A1
(43) Pub. Date: May 19, 2022

(54) METHOD FOR DECOMPOSING AND REMOVING POLLUTANT AND APPARATUS FOR THE SAME

(71) Applicants: National Institute of Advanced Industrial Science and Technology, Tokyo (JP); HIRAYAMA MANUFACTURING CORPORATION, Kasukabe-shi (JP)

(72) Inventors: Tetsushi SUYAMA, Tsukuba (JP); Mamoru KAWAHARASAKI, Tsukuba (JP); Takahisa YOSHIDA, Kasukabe-shi (JP); Chikashi YOSHINAGA, Kasukabe-shi (JP)

(73) Assignees: National Institute of Advanced Industrial Science and Technology, Tokyo (JP); HIRAYAMA MANUFACTURING CORPORATION, Kasukabe-shi (JP)

(21) Appl. No.: 17/519,800

(22) Filed: Nov. 5, 2021

(30) Foreign Application Priority Data
Nov. 19, 2020 (JP) 2020-192351

(51) Int. Cl. C02F 1/02

(52) U.S. Cl. CPC C02F 1/02; C02F 2101/38

(57) ABSTRACT

A method for decomposing and removing a pollutant includes: confining, in a small sealable container, a waste containing the pollutant to be processed and liquid for dilution together with gas containing oxygen or air; disposing the small sealable container in a processing chamber of a high-temperature and high-pressure processing device and keeping the small sealable container at an elevated temperature after the confining; and lowering a temperature in the processing chamber after the disposing. The disposing and the lowering are performed under a state where the small sealable container is pressurized from outside by increasing a pressure in the processing chamber.

### CROSS-REFERENCE TO THE RELATED APPLICATION

This application claims priority under 35 U.S.C.§ 119(a) to Japanese Patent Application No. 2020-192351 filed in Japan on Nov. 19, 2020, the contents of which are hereby incorporated by references.

### TECHNICAL FIELD

This disclosure relates to a method and an apparatus for decomposing and removing a pollutant included in an infectious waste or a biological sample waste, without leaking pollution to a surrounding environment.

### BACKGROUND ART

Infectious wastes and biological sample wastes cannot be discarded unless pollutants contained in these wastes have been properly processed. In addition, during this process, leakage of pollutant to a surrounding environment such as a laboratory will disable an accurate measurement or diagnosis of the pollutant. As a countermeasure against such a problem, Patent Literature 1 (Publication of Japanese Patent No. 6057175) discloses a method for decomposing and removing DNA at a high speed without diffusing pollution to a surrounding environment. In this method, an aqueous solution containing a DNA fragment is confined in a container together with air (or gas containing oxygen), and then, is kept at an elevated temperature in an autoclave. Alternatively, in this method, a waste or the like to which a DNA fragment adhere is placed in a non-sealed container together with water, air, etc., and the non-sealed container is disposed in a processing device, which is capable of confining the contents and held at an elevated temperature. Either method is capable of decomposing and removing DNA with high efficiency without leaking pollution.

### SUMMARY

### Problems

The method of Patent Literature 1 described above is a technique proposed by inventors including some inventors of the present disclosure. In this method, it has been obvious that, when the sealed container is disposed in the autoclave and kept at an elevated temperature, the internal pressure of the sealed container increases. Meanwhile, in order to counteract the increase in the internal pressure and to realize proper processing conditions, delicate control of a device has become necessary. In addition, also in cases where the entire processing device is sealed and kept at an elevated temperature without using a sealed container, it has been uneasy to maintain a uniform temperature distribution in the device, and the device for implementing this method has been inevitably costly. Further, the PCR method (PCR inspection) has been used to diagnose the epidemic novel coronavirus infection (COVID-19) this year, and with an increase in the number of inspections, there is an increasing need to process DNA fragments after inspections in a short processing time.

The certain exemplary embodiments of the present disclosure has been devised in view of such a problem, and an object of certain exemplary embodiments is to provide a method and an apparatus capable of decomposing and removing a pollutant without leaking pollution to a surrounding environment in a short time and at a low cost regardless of an internal pressure of a container. In addition, another object herein is to achieve an advantageous effect that is derived from each configuration illustrated in the following DESCRIPTION OF EMBODIMENTS and that is not obtained by the conventional technique.

### Means to Solve Problems

A method for decomposing and removing a pollutant in an exemplary embodiment disclosed herein includes: a sealing step of confining, in a small sealable container, a waste containing the pollutant to be processed and liquid for dilution together with gas containing oxygen or air; a processing step of disposing the small sealable container in a processing chamber of a high-temperature and high-pressure processing device and keeping the small sealable container at an elevated temperature after the sealing step; and a cooling step of lowering a temperature in the processing chamber after the processing step. The processing step and the cooling step are performed under a state where the small sealable container is pressurized from outside by increasing a pressure in the processing chamber.

An apparatus for decomposing and removing a pollutant in an exemplary embodiment disclosed herein includes: a retort pouch that confines a waste containing the pollutant to be processed and liquid for dilution together with gas containing oxygen or air; a high-temperature and high-pressure processing device including a processing chamber in which the retort pouch after being sealed is disposed; a compressor that maintains or increases a pressure in the processing chamber; a leak valve that releases the pressure from the processing chamber; a pressure detector that detects the pressure in the processing chamber; a temperature detector that detects a temperature in the processing chamber; and a controller that keeps the retort pouch at an elevated temperature in a state where the retort pouch disposed in the processing chamber is pressurized from outside by controlling each operation state of the heater, the compressor, and the leak valve based on the pressure and the temperature respectively detected by the pressure detector and the temperature detector, and cools the retort pouch in the state.

### Effects

According to exemplary embodiments the disclosed method and apparatus for decomposing and removing, it is possible to decompose and remove a pollutant without leaking pollution to a surrounding environment in a short time and at a low cost regardless of an internal pressure of a container.

### BRIEF DESCRIPTION OF DRAWINGS

FIG. 1 is a schematic diagram illustrating an apparatus for decomposing and removing a pollutant according to an embodiment.

FIG. 2 is a flowchart explaining the procedure of a method for decomposing and removing a pollutant, executed by the apparatus of FIG. 1.

FIG. 3 is a graph illustrating a relationship between a temperature and a pressure in a processing step of the method illustrated in FIG. 2.

FIG. 4 is a graph showing a result of an experiment on how processing times vary with processing temperatures in the processing step of the method illustrated in FIG.

### DESCRIPTION OF EMBODIMENTS

With reference to the drawings, description will now be made in relation to a method for decomposing and removing a pollutant and an apparatus for the same as embodiments. The following embodiments are merely illustrative and are not intended to exclude the application of various modifications and techniques not explicitly described therein. The configuration of the embodiments can be implemented with various modifications without departing from the gist thereof. Also, the configuration of the embodiments can be selected as necessary or combined as appropriate.

### <1. Apparatus Configuration>

An apparatus for decomposing and removing a pollutant and a method for the same of the present embodiment decompose and remove a pollutant contained in an infectious waste or a biological sample waste, and can be regarded as an apparatus and a method that remove an infection, inactivate a biological sample, and detoxify the pollutant by confining the pollutant to prevent leakage. In this embodiment, DNA (deoxyribonucleic acid) is exemplified as a pollutant, but the pollutant should not be limited thereto, and may alternatively be RNA (ribonucleic acid) or a chemical substance other than a nucleic acid (e.g., an enzyme or a compound to be thermally denatured and/or thermally decomposed under such conditions).

The method and the apparatus of the present embodiment can be suitably used also in decomposing and removing a nucleic acid stain reagent as a pollutant. The nucleic acid stain reagent is a reagent for staining a nucleic acid, and may be, for example, an intercalator, a minor groove binder, and a fluorescently labeled nucleotide probe.

Alternatively, the method and the apparatus of the present embodiment can be suitably used also in decomposing and removing, as a pollutant, in addition to a nucleic acid, a harmful substance desired to be thermally deactivated after being used in an experiment or an infectious biological sample. The harmful substance is a substance that causes harm to a human body and/or an ecosystem, and may be, for example, a thermally deactivatable proteinous toxin (enterotoxin, verotoxin, ricin toxin, phospholipase, abnormal prion, etc.), a thermally deactivatable alkaloid (aconitine, etc.), or the like. Although a microorganism itself is not a harmful substance (toxin), the toxin produced by the microorganism may be processed together with the microorganism that has produced the toxin. The infectious biological sample is a biological sample that is transmissible, and includes a non-inactivated virus and/or a non-inactivated pathogenic microorganism. The infectious biological sample may be, for example, a clinical or environmental sample that has a possibility of containing coronaviruses, influenza viruses, or the like, a clinical or environmental sample that has a possibility of containing Escherichia coli 0157, a tissue fragment or blood that is unclear whether or not pathogenic bacteria exist, etc.

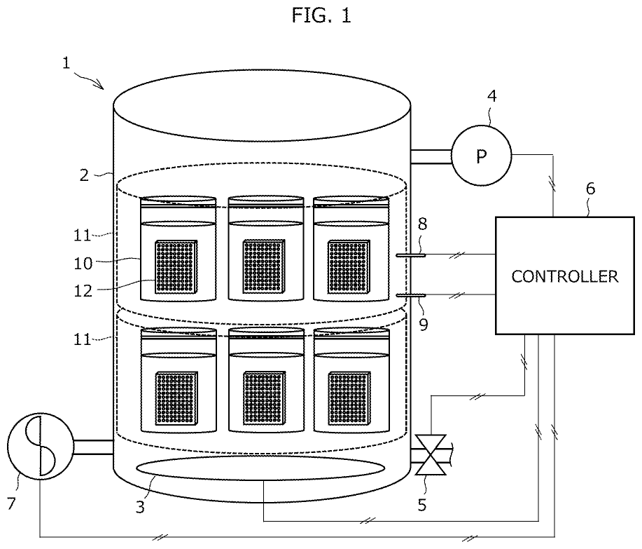

FIG. 1 is a schematic diagram illustrating the apparatus for decomposing and removing a pollutant according to the present embodiment. The present apparatus includes a small sealable container 10 and a high-temperature and high-pressure processing device 1. The small sealable container 10 is used for confining a waste (an infectious waste or a biological sample waste) containing a pollutant to be processed and liquid for dilution together with gas containing oxygen or air. The high-temperature and high-pressure processing device 1 includes a processing chamber 2 in which the small sealable container 10 is disposed. The small sealable container 10 is preferably a retort pouch having an internal volume of 0.5 liters or more and 2.0 liters or less (also referred to as “0.5 to 2.0 L”), and more preferably, is the retort pouch in a transparent color which makes the retort pouch see-through such that an inside thereof is visible from outside.

The present embodiment illustrates an example in which the retort pouch is used as the small sealable container 10. Hereinafter, the small sealable container 10 is referred to as “retort pouch 10”. The retort pouch 10 is a bag formed of a material (e.g., resin or aluminum) which at least has: high heat resistance that prevents the contents from leaking (that can sustain the initial basic shape) even when the retort pouch 10 is disposed in a space at a processing temperature to be described later (i.e., has a heat resisting temperature higher than the processing temperature); and flexibility that allows the position, etc. of the contents to be modified from the outside of the retort pouch 10. The opening of the retort pouch 10 is provided with a part (sealing part) having a sealing function for sealing the retort pouch 10. The configuration of the sealing part is not particularly limited, and may be any configuration as long as it forms a sealed space to prevent the gas and liquid in the retort pouch 10 from leaking to the outside. The retort pouch 10 of the present embodiment is in a transparent color that allows the inside thereof to be seen through, so that the contents thereof is visually recognizable from outside.

The present embodiment illustrates an example in which an autoclave is used as the high-temperature and high-pressure processing device 1. Hereinafter, the high-temperature and high-pressure processing device 1 is referred to as “autoclave 1”. The autoclave 1 is a high-pressure steam sterilizer, which performs sterilization treatment under an elevated pressure by using steam at an elevated temperature of, for example, 120° C. or higher. The autoclave 1 may be a degassing type in which air in the interior of the processing chamber 2 (hereinafter, referred to as “in the processing chamber 2”) is degassed, or a non-degassing type in which air in the processing chamber 2 is not degassed.

The autoclave 1 used in this embodiment is not a commercially available autoclave capable of achieving a “120° C., 2 atm”, but a high-performance autoclave capable of realizing at least a temperature higher than 120° C. (more preferably, also capable of realizing a pressure higher than 2 atm). In the processing chamber 2 of the autoclave 1 (e.g., near the bottom of the processing chamber 2), there is provided a heater 3 that generates steam by heating water injected into the processing chamber 2. The operation state (ON/OFF) of the heater 3 is controlled by a controller 6 which will be described later.

In addition to the retort pouch 10 and the autoclave 1, the present apparatus includes a compressor 4 that mainly increases the pressure in the processing chamber 2 of the autoclave 1, a leak valve 5 that releases the pressure from the processing chamber 2, a pressure sensor 8, a temperature sensor 9, and the controller 6. Further, the apparatus of the present embodiment includes a cooler 7 that actively cools the interior of the processing chamber 2 to forcibly lower the temperature in the processing chamber 2. Hereinafter, these elements will be described in order.

The compressor 4 is a pressure pump that maintains or increases the internal pressure of the processing chamber 2 by feeding air into the processing chamber 2. In contrast, the leak valve 5 is a valve (e.g., a solenoid valve) that lowers the pressure in the processing chamber 2 by releasing the pressure from the processing chamber 2. The respective operation states of the compressor 4 and the leak valve 5 are controlled by the controller 6. The pressure sensor 8 is a pressure detector and may represent a detecting means that detects the pressure in the processing chamber 2, and the temperature sensor 9 is a temperature detector and may represent a detecting means that detects the temperature in the processing chamber 2. The information detected by these sensors 8 and 9 is transmitted to the controller 6. The cooler 7 is a device that cools the interior of the processing chamber 2 after completion of decomposing and removing the pollutant, and may be, for example, a cooling fan or a cooling shower. The operation state of the cooler 7 is controlled by the controller 6.

The controller 6 is a control board or an electronic control device including a microprocessor and a storing unit such as a ROM, a RAM, or the like, and performs a control relating to a decomposing and removing treatment for the pollutant. The pressure sensor 8 and the temperature sensor 9 described above are connected to input ports of the controller 6. Specific control targets of the controller 6 include each operation state of the heater 3, the compressor 4, and the cooler 7, and the open/close state of the leak valve 5. The controller 6 of the present embodiment keeps the retort pouch 10 at an elevated temperature in a state where the retort pouch 10 disposed in the processing chamber 2 is pressurized from outside by controlling each operation state of the heater 3, the compressor 4, and the leak valve 5 based on the pressure and the temperature respectively detected by the pressure sensor 8 and the temperature sensor 9, and cools the retort pouch 10 in the state where the retort pouch 10 is pressurized.

### <2. Method>

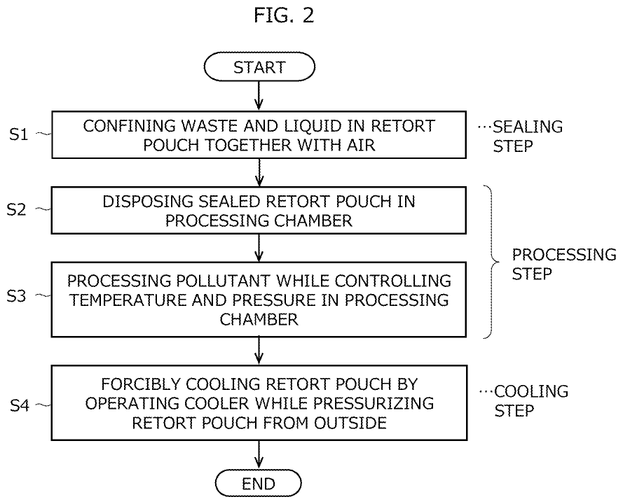

FIG. 2 is a flowchart that explains the procedure of the method for decomposing and removing a pollutant according to the present embodiment. The present method consists of three steps: a sealing step, a processing step, and a cooling step; and carries out these steps in this order. The sealing step and the first half of the processing step are carried out manually by an operator (human), and the second half of the processing step and the cooling step are carried out by the controller 6. That is, the second half of the processing step and the cooling step correspond to the “control relating to a decomposing and removing treatment” described above. As an alternative to manually performing the sealing step and the first half of the processing step by an operator, all steps may be fully automated by using a robot or the like. In this case, all of the steps correspond to the “control relating to a decomposing and removing treatment”. Conversely, the second half of the processing step and the cooling step may be manually carried out by an operator instead of being carried out by the controller 6.

In the sealing step, a waste containing the pollutant to be processed and liquid for dilution are confined in the retort pouch 10 together with gas containing oxygen or air (step S1). Examples of the liquid for dilution include water, an acid or alkaline solution for adjusting the pH of the processing liquid, and an aqueous solution containing the acid or alkaline solution.

For example, in a case where the waste is a DNA fragment used in a PCR inspection, firstly, a test container 12 (e.g., a PCR tube, a 384-well tray, etc.) in which a solution containing the DNA fragment is enclosed is put, without being opened, into the retort pouch 10, secondly, the liquid for dilution is poured into the retort pouch 10, and thirdly, the retort pouch 10 is sealed while containing air. In this case, i.e. when the test container 12 is put, without being opened, into the retort pouch 10, a jig (not illustrated) for opening the test container 12 is also put into the retort pouch 10, and after the retort pouch 10 is sealed, the test container 12 is opened by the operation (usage) of the jig from the outside of the retort pouch 10. Incidentally, the test container 12 after being opened may be put into the retort pouch 10, which obviates a need to put the jig.

In the next processing step, firstly, the retort pouch 10 in a sealed state is disposed in the processing chamber 2 of the autoclave 1 (step S2). At this time, as illustrated in FIG. 1 for example, multiple retort pouches 10 may be disposed in a basket 11, and the basket 11 may be disposed in the processing chamber 2. At this point, the test container 12 in the retort pouch 10 is already opened. Then, the lid of the autoclave 1 is closed, and the interior of the processing chamber 2 is kept at an elevated temperature by the control of the temperature and the pressure in the processing chamber 2 to process the pollutant (step S3). In step S3, while the elevated temperature is being kept, the temperature and the pressure in the processing chamber 2 are detected by the sensors 8 and 9, and each operation state of the heater 3, the compressor 4, and the leak valve 5 is controlled according to the detected temperature and pressure.

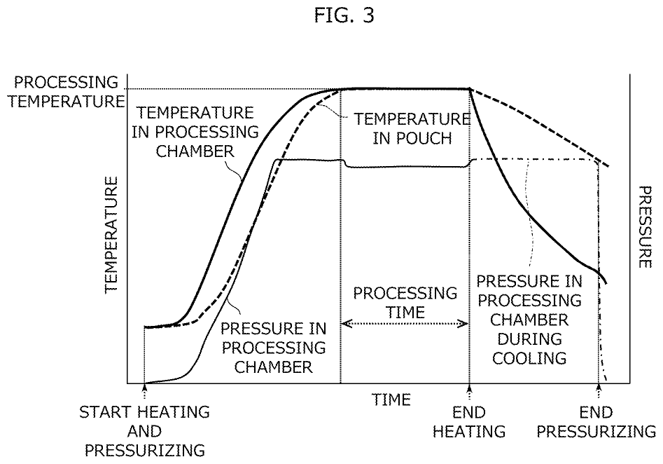

Here, the relationship between the temperature and the pressure during the processing step is illustrated in FIG. 3. The horizontal axis in FIG. 3 represents a progress of time, in which the steps progress from left to right. Firstly, when the heater 3 is turned from off to on and heating is started, the temperature in the processing chamber 2 (the bold solid line in the drawing) begins to rise, and in response to this, the temperature in the retort pouch 10 (the bold broken line in the drawing, hereinafter also referred to as “pouch temperature”) also begins to rise. Since air is contained in the retort pouch 10, the pressure in the retort pouch 10 (hereinafter also referred to as “pouch internal pressure”) also increases with the temperature. The pressure in the processing chamber 2 increases due to the saturated steam and residual air, and after becoming a pressure equal to or higher than the saturated steam pressure, pressurizes the retort pouch 10 from outside. This ensures the pressure in the processing chamber 2 against an increase in the pouch internal pressure, preventing break-off due to thermal expansion of the retort pouch 10. Incidentally, the internal pressure of the processing chamber 2 is adjusted by the compressor 4 and the leak valve 5 as necessary.

Specifically, in the method of the present embodiment, when the retort pouch 10 is kept at an elevated temperature, the pressure in the processing chamber 2 is maintained equal to or higher than the saturated steam pressure by the heater 3, the compressor 4, and the leak valve 5. Then, while the temperature in the processing chamber 2 is lowered by the control of the cooler 7 after the end of a processing time (after completion of decomposing and removing), the pressure in the processing chamber 2 (the thin solid line in the drawing) is maintained higher than the pouch internal pressure by the control of the operation state of the compressor 4, and thereby, the temperature in the processing chamber 2 and the pouch temperature are both lowered in a state where the retort pouch 10 is pressurized from outside. This enables the retort pouch 10 in the sealed state to be kept at the elevated temperature and to be cooled from the elevated temperature without breaking-off. The value (pressure value, compressor output) to be pressurized by the compressor 4 increases with the pouch temperature. This is because the saturated steam pressure in the retort pouch 10 increases with the pouch temperature.

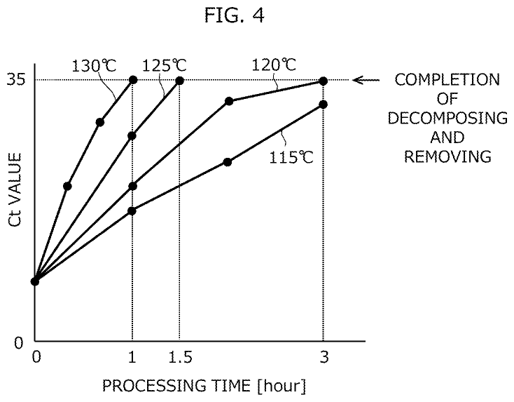

In the processing step, the temperature in the processing chamber 2 and the pouch temperature both reach the processing temperature (e.g., a predetermined temperature between 120° C. to 135° C.), and then, the processing temperature is maintained until the processing time (e.g., 0.5 hours to 3 hours) required at the processing temperature elapses. FIG. 4 is a graph showing a result of an experiment on how the processing times vary with the processing temperatures. Although the details will be described in the following Examples, this graph shows the result of the experiment performed at four stages of 115° C., 120° C., 125° C., and 130° C., as the processing temperatures. As is apparent from FIG. 4, it was conceived that the case of the processing temperature being 120° C. required the processing time of 3 hours, whereas the case of the processing temperature being 125° C. required the processing time of 90 minutes, and the case of the processing temperature being 130° C. required the processing time of 1 hour to complete the decomposing and removing. From this result, it can be anticipated that, if the processing temperature can be increased to a temperature higher than 130° C. (e.g., 135° C.), the processing time can be further shortened.

Since the pouch temperature increases with the processing temperature, the pouch internal pressure also increases, but as a countermeasure against this, an increase in the pressure in the processing chamber 2 can prevent the break-off of the retort pouch 10. On the contrary, when the pressure in the processing chamber 2 is excessively increased, degassing is performed by opening the leak valve 5. When the processing time has elapsed, the heater 3 is turned off to end the heating. Incidentally, as described above, the higher the processing temperature is, the shorter the processing time becomes.

In the cooling step after the processing step, the temperature in the processing chamber 2 is forcibly lowered by the cooler 7 (step S4). When the heater 3 is turned off, the temperature in the processing chamber 2 and the pouch temperature both decrease, but the pouch temperature decreases at a smaller gradient as compared to the temperature in the processing chamber 2. In view of this, immediately before the cooling step, the compressor 4 is operated, and while the pressure in the processing chamber 2 is maintained by the control of the operation state of the compressor 4, the temperature in the processing chamber 2 and the pouch temperature are both lowered. This suppresses an expansion of the retort pouch 10 which is caused by: a difference between the temperature in the processing chamber 2 and the pouch temperature; and a difference in a coefficient of thermal expansion originating from a difference between gas composition in the processing chamber 2 and gas composition in the retort pouch 10, and thereby, prevents the break-off of the retort pouch 10. That is, in the cooling step, while the retort pouch 10 is pressurized from outside by the control of the pressure, the cooler 7 is operated to quickly lower the temperature in the processing chamber 2. When the pouch temperature is sufficiently lowered and the risk of the break-off is eliminated, the compressor 4 is stopped.

### 3. Advantageous Effect

(1) According to the method and the apparatus described above, by pressurizing the retort pouch 10 from outside by the increased pressure in the processing chamber 2 in the processing step and the cooling step, the break-off of the retort pouch 10 as the small sealable container can be prevented. This enable the retort pouch 10 to be kept at the elevated temperature and to be cooled from the elevated temperature without breaking-off even when the pouch internal pressure increases. In addition, even if the pouch internal pressure increases with the processing temperature, since the break-off of the retort pouch 10 can be prevented, the processing time can be shortened. Further, in the processing step and the cooling step, since it is only necessary to pressurize the retort pouch 10 from outside by increasing the pressure in the processing chamber 2, there is no need to maintain a uniform temperature distribution in the apparatus, so that a low cost can be realized. Accordingly, it is possible to decompose and remove the pollutant in a short time and at a low cost regardless of the pouch internal pressure.

Further, since the waste is processed inside the retort pouch 10, the pollutant can be decomposed and removed while being confined and without leaking pollution to the surrounding environment. Furthermore, since the retort pouch 10, which serves as the small sealable container, is flexible as well as highly airtight, even after sealing the retort pouch 10 that receives the entire test container 12 enclosing the waste, it is possible to open the test container 12 (e.g. the lid of the PCR tube or the cover of the tray) in the retort pouch 10 from the outside of the retort pouch 10. This also prevents the pollutant from leaking to the outside, contributing to preservation of the surrounding environment. In addition, by using the small retort pouch 10 having the internal volume of 0.5 liters or more and 2.0 liters or less, it is possible to efficiently process multiple retort pouches 10 in a single time and also to easily realize an optimum condition for decomposing in the interior of the retort pouch 10. Further, since the retort pouch 10 is highly versatile, inexpensive, easy to handle, and discardable as a whole, it is possible to reduce the cost and to enhance operability throughout a series of decomposing and removing steps.

(2) By using the above-described method and apparatus in decomposing and removing a nucleic acid (DNA, RNA), a nucleic acid stain reagent, a harmful substance desired to be thermally deactivated after being used in an experiment, or an infectious biological sample, as the pollutant, the decomposing and removing can be achieved without leaking pollution.

(3) According to the autoclave 1 described above, which includes the heater 3, the compressor 4, and the leak valve 5, the decomposing and removing of the pollutant can be achieved in an appropriate processing time while the retort pouch 10 is reliably prevented from breaking-off in any of the steps.

(4) If the retort pouch 10 is transparent, the inside of the retort pouch 10 is visually recognizable from outside, which makes it possible to open the sealed test container 12 (the PCR tube or the tray) containing the waste in the retort pouch 10 by the operation from the outside of the retort pouch 10. This avoids the pollutant from being exposed to the outside the retort pouch 10, achieving a higher pollution preventing effect.

(5) According to the method and the apparatus described above, since the cooling step of forcibly lowering the temperature in the processing chamber 2 by the cooler 7 is performed, it is possible to quickly lower the temperature in the processing chamber 2 and to shorten the time in a series of the decomposing and removing.

### <4. Miscellaneous>

The apparatus described above is an example, and the method is also an example. For instance, the cooler 7 is not essential and can be omitted. In such a case, in the cooling step after the processing step, the temperature in the processing chamber 2 may be lowered naturally with the pressurization. The high-temperature and high-pressure processing device should not be limited to the autoclave 1, and alternatively, for example, by adding a compressor to an oven or an electric heater, the same effects as the embodiment described above can be obtained. Further, the small sealable container should not be limited to the retort pouch 10, and various small sealable containers are applicable as long as the containers are formed of an elastic material that may expand with an increase in the internal pressure. Even when the retort pouch 10 is used, there is no particular limitation on the type or the color of the retort pouch 10, and a translucent or colored retort pouch may be used alternatively. The above-described method and apparatus are applicable not only to a case of decomposing and removing a nucleic acid, but also to a case of decomposing and removing a pollutant contained in an infectious waste or a biological sample waste.

### EXAMPLES

Hereinafter, the present disclosure will be described in further detail with reference to Examples and Comparative Examples. The following Examples are presented to illustrate the present disclosure in detail, and the present disclosure should not be limited to the following Examples unless departing from the gist thereof.

### Example 1

1. 300 mL of tap water was poured into a retort pouch (ESCF-TN0900 type manufactured by COW PACK CO., LTD., width 160 mm×height 240 mm×bottom gusset 40.5 mm), and while about 200 mL of air was left in the headspace of the retort pouch, the opening was welded with an FV802-01 type tabletop heat sealer manufactured by HAKKO Corporation. In addition, to check the condition of the retort pouch, another two retort pouches were filled with 450 mL and 600 mL of tap water, respectively, and while air was left in each headspace, the openings were similarly welded.

2. The above-described three types of sealed retort pouches were disposed in a processing chamber of a prototype of the high-temperature and high-pressure processing device. When the device was operated under the condition where the processing temperature was 125° C. and the processing time was 1 hour, all of the retort pouches were kept stable in all of the heating, the processing, and the cooling steps.

### Comparative Example 1

300 mL of tap water was poured into a retort pouch similar to Example 1 described above, and in the same manner as the above, while air was left in the headspace of the retort pouch, the opening was welded.

Using a conventional autoclave, multiple sealed retort pouches each prepared as described above were disposed in a processing chamber, and while normal degassing was performed, the autoclave was operated under the condition where the processing temperature was 121° C. and the processing time was 20 minutes, without pressurization by the compressor until the heating, the processing, and the cooling steps were completed. As a result, all of the retort pouches broke-off from inside.

### Comparative Example 2

150 mL, 300 mL, 600 mL of tap water were respectively poured into retort pouches similar to Example 1 described above, and in the same manner as the above, while air was left in each headspace of the retort pouches, the openings were welded.

Using a conventional retort sterilizer, the above-described three types of sealed retort pouches were disposed in a processing chamber, and the sterilizer was operated under the condition of 121° C. and sterilization time of 20 minutes while the processing chamber was degassed and heated without the activation of the compressor during the process. As a result, the retort pouch of 600 mL broke-off from the inside, and thus, in percentage, 33% of the retort pouches broke-off from inside.

### Example 2

A 300 mL of Milli-Q water was poured into a retort pouch similar to Example 1 described above, and then, a solution of a model PCR waste as described in the prior patent (Patent Literature 1) was added to evaluate the ability for decomposing DNA by using the same method as in the prior patent, which led to the result of FIG. 4. Referring to samples obtained by gradually diluting the model PCR waste, it was confirmed that the Ct value of the sample before the process was 8, and the Ct value of the sample decomposed to have the template activity reduced by about seven orders of magnitude was 35. It was found that the processing time required to reduce the template activity of DNA by seven orders of magnitude was: 3 hours at a processing temperature of 120° C.; 90 minutes at a processing temperature of 125° C.; and 1 hour at a processing temperature of 130° C.

### INDUSTRIAL APPLICABILITY

According to certain exemplary embodiments of the present disclosure, it is possible to decompose and remove a nucleic acid or a chemical substance (an enzyme or a compound to be thermally denatured and/or thermally decomposed under such conditions) other than a nucleic acid without leaking pollution. The present disclosure is effective in medical treatment or in processing experimental wastes or the like.

### DESCRIPTION OF REFERENCE SIGNS

1 Autoclave (high-temperature and high-pressure processing device)
2 Processing chamber
3 Heater
4 Compressor
5 Leak valve
6 Controller
7 Cooler
8 Pressure sensor (pressure detecting means)
9 Temperature sensor (temperature detecting means)
10 Retort pouch (small sealable container)
11 Basket
12 Test container

What is claimed is:

1. A method for decomposing and removing a pollutant, the method comprising:
confining, in a small sealable container, a waste containing the pollutant to be processed and liquid for dilution together with gas containing oxygen or air;
disposing the small sealable container in a processing chamber of a high-temperature and high-pressure processing device and keeping the small sealable container at an elevated temperature after the confining; and
lowering a temperature in the processing chamber after the disposing, wherein
the disposing and the lowering are performed under a state where the small sealable container is pressurized from outside by increasing a pressure in the processing chamber.

2. The method according to claim 1, wherein the small sealable container is a retort pouch having an internal volume of 0.5 liters or more and 2.0 liters or less.

3. The method according to claim 1, wherein the pollutant is a nucleic acid.

4. The method according to claim 1, wherein the pollutant is a nucleic acid stain reagent.

5. The method according to claim 1, wherein the pollutant is a harmful substance desired to be thermally deactivated after being used in an experiment or an infectious biological sample.

6. The method according to claim 1, wherein
the high-temperature and high-pressure processing device comprises a heater that heats an interior of the processing chamber, a compressor that maintains or increases the pressure in the processing chamber, and a leak valve that releases the pressure from the processing chamber,
the disposing is performed by detecting the temperature and the pressure in the processing chamber while the elevated temperature is being kept, and by controlling each operation state of the heater, the compressor, and the leak valve according to the detected temperature and the detected pressure, and
the lowering is performed by suppressing an expansion of the small sealable container by controlling the operation state of the compressor, the expansion being caused by a difference in temperature between the processing chamber and the small sealable container and a difference in a coefficient of thermal expansion originating from a difference between gas composition in the processing chamber and gas composition in the small sealable container.

7. The method according to claim 2, wherein
the high-temperature and high-pressure processing device comprises a heater that heats an interior of the processing chamber, a compressor that maintains or increases the pressure in the processing chamber, and a leak valve that releases the pressure from the processing chamber,
the disposing is performed by detecting the temperature and the pressure in the processing chamber while the elevated temperature is being kept, and by controlling each operation state of the heater, the compressor, and the leak valve according to the detected temperature and the detected pressure, and
the lowering is performed by suppressing an expansion of the small sealable container by controlling the operation state of the compressor, the expansion being caused by a difference in temperature between the processing chamber and the small sealable container and a difference in a coefficient of thermal expansion originating from a difference between gas composition in the processing chamber and gas composition in the small sealable container.

8. The method according to claim 1, wherein the small sealable container is see-through such that an inside thereof is visible from outside.

9. The method according to claim 2, wherein the small sealable container is see-through such that an inside thereof is visible from outside.

10. The method according to claim 6, wherein the small sealable container is see-through such that an inside thereof is visible from outside.

11. The method according to claim 7, wherein the small sealable container is see-through such that an inside thereof is visible from outside.

12. The method according to claim 1, wherein
the high-temperature and high-pressure processing device comprises a cooler that cools an interior of the processing chamber, and
the lowering is performed by forcibly lowering the temperature in the processing chamber by using the cooler.

13. The method according to claim 2, wherein
the high-temperature and high-pressure processing device comprises a cooler that cools an interior of the processing chamber, and
the lowering is performed by forcibly lowering the temperature in the processing chamber by using the cooler.

14. The method according to claim 6 wherein
the high-temperature and high-pressure processing device comprises a cooler that cools an interior of the processing chamber, and
the lowering is performed by forcibly lowering the temperature in the processing chamber by using the cooler.

15. The method according to claim 7 wherein
the high-temperature and high-pressure processing device comprises a cooler that cools an interior of the processing chamber, and
the lowering is performed by forcibly lowering the temperature in the processing chamber by using the cooler.

16. The method according to claim 8 wherein
the high-temperature and high-pressure processing device comprises a cooler that cools an interior of the processing chamber, and
the lowering is performed by forcibly lowering the temperature in the processing chamber by using the cooler.

17. The method according to claim 9 wherein
the high-temperature and high-pressure processing device comprises a cooler that cools an interior of the processing chamber, and
the lowering is performed by forcibly lowering the temperature in the processing chamber by using the cooler.

18. The method according to claim 10 wherein
the high-temperature and high-pressure processing device comprises a cooler that cools an interior of the processing chamber, and
the lowering is performed by forcibly lowering the temperature in the processing chamber by using the cooler.

19. The method according to claim 11 wherein
the high-temperature and high-pressure processing device comprises a cooler that cools an interior of the processing chamber, and
the lowering is performed by forcibly lowering the temperature in the processing chamber by using the cooler.

20. An apparatus for decomposing and removing a pollutant, the apparatus comprising:
a retort pouch configured to confine a waste containing the pollutant to be processed and liquid for dilution together with gas containing oxygen or air;
a high-temperature and high-pressure processing device including a processing chamber in which the retort pouch after being sealed is disposed;
a compressor configured to maintain or to increase a pressure in the processing chamber;
a leak valve configured to release the pressure from the processing chamber;
a pressure detector configured to detect the pressure in the processing chamber;
a temperature detector configured to detect a temperature in the processing chamber; and
a controller configured to keep the retort pouch at an elevated temperature in a state where the retort pouch disposed in the processing chamber is pressurized from outside by controlling each operation state of the heater, the compressor, and the leak valve based on the pressure and the temperature respectively detected by the pressure detector and the temperature detector, and cools the retort pouch in the state.
